(19) United States
(12) Patent Application Publication
(10) Pub. No.: US 2004/0139843 A1
(43) Pub. Date: Jul. 22, 2004

(54) Music notation system

(76) Inventor: Marilyn Forster, Huron, OH (US)

Correspondence Address: RANKIN, HILL, PORTER & CLARK, LLP, 925 EUCLID AVENUE, SUITE 700, CLEVELAND, OH, 44115-1405, US

(21) Appl. No.: 10/348,248

(22) Filed: Jan. 21, 2003

(51) Int. Cl. G09B 15/02

(52) U.S. Cl. 84/483.2

(57) ABSTRACT

The present invention provides a system for music notation, and includes a musical staff. The musical staff includes a 20-line grid of horizontal lines and spaces, wherein 10 lines form a treble clef staff portion and 10 lines form a bass clef staff portion. The 10 lines of each staff portion are divided into subportions of 4 lines and 6 lines. The staff may further include a ledger line between the treble clef staff portion and bass clef staff portion, and a ledger line between each subportion of 4 and 6 lines of each staff, wherein the ledger line is adapted to always receive the note C. This eliminates the need for counting multiple ledger lines to decipher notes in a musical composition that are sounded well above the traditional treble or bass staves. The treble clef staff portion may further include a clef that identifies each line and space where the note G may be placed. The bass clef staff portion may further include a clef that identifies each line and space where the note F may be placed.

### FIELD OF INVENTION

The present invention relates to musical notation, and more particularly to music scoring and staffs.

### BACKGROUND OF THE INVENTION

Musical notation defines the pitch and duration of individual elements or sounds that we call notes. The notes are represented by symbols (e.g., z,900 , z,901 ) that are also called notes. A row of notes steadily rising in pitch is named successively using the first seven letters of the Roman alphabet, i.e. A, B, C, D, E, F, G. The stems, flags or beams attached to the note and whether the note is filled-in are used to designate the duration of the note.

If the same row of notes continues to rise in pitch, the sequence will repeat starting again with A. The notes are placed on a grid of horizontal lines separated by spaces called a staff. The staff used almost universally today has five lines separated by four spaces. Notes may lie on a line, in the space between two lines, in the space above the top line or on the space below the bottom line. When notes are outside the range covered by the lines and spaces, the notes may be placed above or below the staff on or between shorter lines, called ledger lines. Notes having higher pitches will be placed higher up on the staff.

To establish the pitch of any note on the staff, a graphical symbol called a clef, from the Latin clavis, (meaning key), is placed at the far left-hand side of the staff. The clef establishes the pitch of one particular note on the staff and thereby fixes the pitch of all the other notes lying on, or related to, the same staff. Two commonly used clefs are the treble clef (z,902 ), or G clef, and the bass clef (z,903 ), or F clef. It is common practice to provide the staffs associated with each clef together as a part of a larger system known as the “grand staff.” The grand staff comprises two staffs, an upper staff bearing the treble clef and a lower staff bearing the bass clef. The note we call middle C lies on a single ledge line between the two staffs, that is, one ledger line below the five lines of the staff having the treble clef and one line above the five lines of the staff having the bass clef. The grand staff is commonly used to score works for the piano, and it is also used for some choral singing.

The treble clef is also called the G clef because the inner curve of the clef symbol marks the horizontal line associated with the note G above middle C, and the treble clef symbol itself is actually a stylized letter G. The bass clef is also called the F clef because the two dots in the clef symbol lie above and below the horizontal line associated with the note F below middle C, and the bass clef symbol itself is actually a stylized letter F where the two horizontal lines of the letter have been reduced to two dots. There are other clefs used in music notation, such as the C clef (z,904 ), which is so named because the clef symbol is centered on the horizontal line associated with the note middle C.

Once the musical line goes above or below the five lines of the staff, ledger lines must be used to mark their pitch. It is easy enough to quickly read the pitch of a note one or two ledger lines above or below the staff. However, a performer is increasingly prone to error once the notes appear many ledger lines above or below the staff. Often, performers must take the time to write the names of notes on ledger lines which clutters the page instead of organizing it.

There have been several prior art attempts at creating a musical notation system that is easier to read above and below the traditional staff. Some systems have added a line to the staff above and/or below the staff. Other systems have added a second staff both above and below the grand staff, adding a grid of 5 lines and 4 spaces above the treble clef and below the bass clef. These systems still must use several ledger lines between staves, and remain visually confusing. Notation in any field should be intuitive, clear and easy to follow. Therefore, there remains a need for a musical notation system that reduces the need for ledger lines and is easy to read.

### SUMMARY OF INVENTION

In response to the foregoing concerns, the present invention presents a new system of musical notation. The present invention provides a new staff for musical notation or scoring. The musical staff comprises an integrated staff system replacing the grand staff common used currently. Preferably, the music staff of the present invention comprises a 20-line grid of horizontal lines and spaces, wherein 10 lines form a treble clef staff portion and 10 lines form a bass clef staff portion, and the 10 lines of each staff are divided into staff subportions of 4 lines and 6 lines. The 6-line subportion of each staff is preferably adjacent middle C.

The staff of the present invention may further provide for a single ledger line between the treble clef staff portion and bass clef staff portion, and a single ledger line between each set of 4 and 6 lines of each staff portion. In each instance, this single the ledger line is adapted to receive the note C (in different octaves). This substantially eliminates the need for counting ledger lines to decipher notes in a musical composition within an ordinary range of a few octaves on either side of middle C.

The sets of lines in each portion of the staff of the present invention are arranged in a formation of four lines, six lines, six lines, and four lines, reading from the lowest tones to the highest tones, respectively. This is referred to as a 4-6-6-4 pattern. The use of a 4-6-6-4 pattern is advantageous when compared to prior art staves, including staves having a 5-5-5-5 pattern. Using a 4-6-6-4 pattern, it is simpler to tell where middle C is located.

Another advantage of the 4-6-6-4 pattern is that it utilizes the 6 line staff subportion on each side of middle C. A staff subportion of 6 lines together with the single ledger line used with each staff subportion provides for a system whereby exactly two octaves (each comprising a scale of 7 notes) fit on a single 6-line staff subportion. In other words, a note on the bottom line of a 6-line staff subportion is always E, a note on the next line above is always G, and so forth.

The treble clef staff portion may further comprise a unique clef that identifies each line and space where the note G may be placed in different octaves, rather than merely identify the note G in a single octave. Similarly, the bass clef staff portion may further comprise a clef that identifies each line and space where the note F may be placed in different octaves, rather than merely identify the note F in a single octave.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1 is an illustration of an extract of a musical composition utilizing the prior art music notation system.

FIG. 2 is an illustration of the staff provided by the music notation system of the present invention.

FIG. 3 is an illustration of the placement of notes on the staff of the present invention.

FIG. 4 is an illustration of the various key signatures on the staff of the present invention.

FIG. 5 is an illustration of the extract of the musical composition of FIG. 1 utilizing the music notation system of the present invention.

### DETAILED DESCRIPTION OF PREFERRED EMBODIMENTS

The present invention relates to a system for musical notation. The system for musical notation comprises a musical staff for receiving notes. The musical staff comprises a 20-line grid of horizontal lines and spaces, wherein 10 lines form a treble clef staff and 10 lines form a bass clef staff. The 10 lines of each staff portion are divided into subportions of 4 lines and 6 lines. All of the lines in each of the staff subportions are equally spaced from each other, so that each staff subportion functions as a staff for the arrangement of notes on the lines or in the spaces between the lines. Each staff subportion is spaced from an adjacent staff subportion by a discernibly greater distance that the space between the lines in each staff subportion, so that the lines of each staff subportion are grouped together and the staff subportions can be readily distinguished from each other.

The staff of the present invention additionally comprises a single ledger line between each staff subportion. A single ledger line is located between the treble clef staff portion and bass clef staff portion, and between the subportions of 4 and 6 lines of each staff portion. This single ledger line always receives the note C in the applicable octave. The treble clef staff portion further comprises a clef that identifies each line and space where the note G may be placed. The bass clef staff portion further comprises a clef that identifies each line and space where the note F may be placed.

The musical notation system may further comprise a key signature comprising sharps or flats arranged on the treble clef staff and/or the bass clef staff, wherein the arrangement of sharps or flats on the treble clef staff is identical to the arrangement of sharps or flats on the bass clef staff for any given key signature.

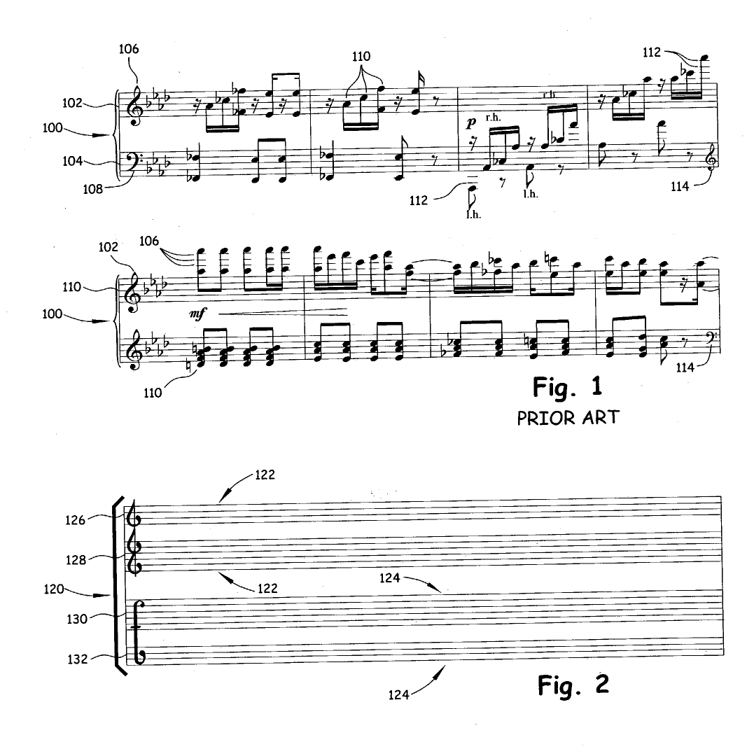

FIG. 1 illustrates an excerpt from a musical composition using the most widely used prior art notation system. The grand staff 100 includes both the treble clef staff 102 and the bass clef staff portion 104. The treble clef staff 102 is indicated by the treble clef 106 (or G clef) positioned on the staff. The bass clef staff 104 is indicated by the bass clef 108 (or F clef) positioned on the staff. Multiple notes 110 are placed on the grand staff 100 to indicate the pitch and length of the tones to be played by musical instruments or sung by voices. The conventional grand staff 100 accommodates notes within a certain range of pitches, and notes that are above or below this range of pitches are placed on ledger lines 112. Sometimes, adjustments such as a clef change 114 are necessary to arrange certain pieces of music because the pitches are so far above the range of their clef.

FIG. 2 illustrates the arrangement of lines and spaces that comprise the musical notation system of the present invention. The staff 120 of the present invention comprises an arrangement of 20 lines and spaces. The lines and spaces are arranged into subportions of 6 lines and 4 lines. Similar to the grand staff 100, the staff 120 of the present invention comprises a treble clef portion 122 and a bass clef portion 124. The treble clef portion 122 in turn is divided into an upper 4-line subportion 126 and a lower 6-line subportion 128. Similarly, the bass clef portion 124 is divided into an upper 6-line subportion 130 and a lower 4-line subportion 132.

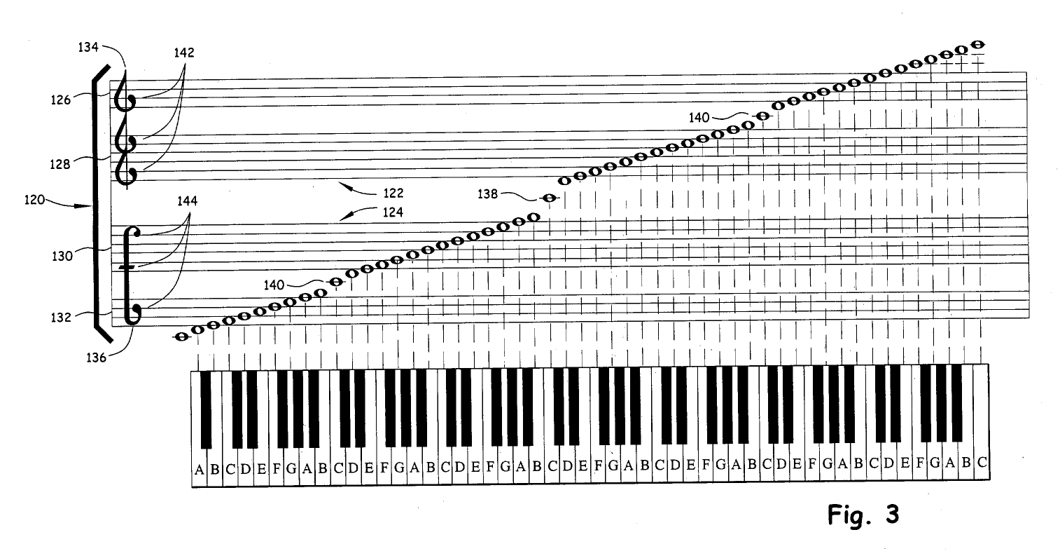

FIG. 3 is another illustration of staff 120 using the treble clef symbol 134 of the present invention and the bass clef symbol 136 of the present invention. Letters indicating tones of notes and the corresponding keyboard key are also indicated on staff 120 in FIG. 3.

The staff 120 of the present invention may further comprise a single ledger line 138 between the treble clef portion 122 and the bass clef portion 124, and a single ledge line 140 between each subportion of 6 lines and 4 lines. Using the musical notation system of the present invention, the ledger lines 138 and 140 are unique in that they will always have the note C placed on the line. This consistency aids the reader in deciphering notes quickly. The fact that the note C is the only note to appear on the ledger line between the staff subportions is attributable to the unique arrangement of a 4-lines staff subportion, a 6-line subportion, another 6-lines subportion, and a 4-line subportion extending from the lowest tones of the bass clef portion 124 to the highest tones of the treble clef portion 122, which will herein be referred to as the 4-6-6-4 pattern.

The treble clef 134 indicates the location of all of the G notes 142 on the staff of the treble clef portion 122. The treble clef 134 comprises a series of three curves with a vertical line through the series of curves. The curves terminate in a flat line on the line or space where the note G is placed on the clef.

Similarly, the bass clef 136 indicates the location of all of the F notes 144 on the bass clef portion 124. The bass clef 136 comprises a vertical line with curves at each end of the line and a horizontal line. The ends of each curve terminate at the lines where F notes are placed, and the horizontal line is placed in the space where another F is placed.

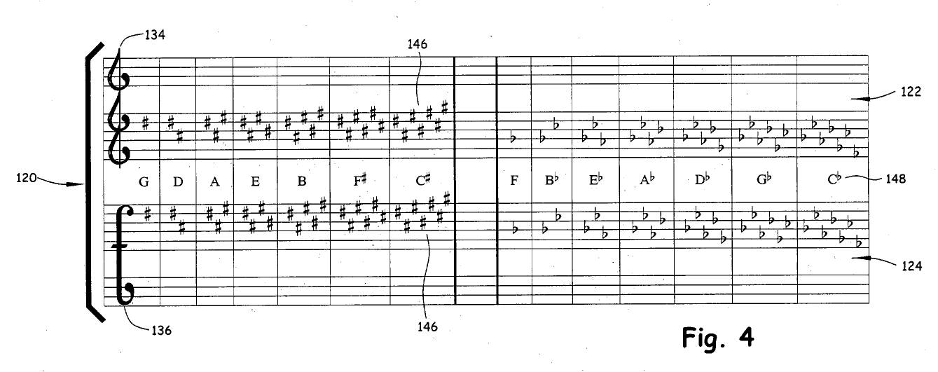

FIG. 4 illustrates the key signatures 146 of staff of the present invention 120. The key signatures 146 of all of the keys 148 using sharps (G, D, A, E, B, F♯, C♯) are indicated in FIG. 4, as well as all of the keys 148 using flats (F, B♭, E♭, A♭, D♭, G♭, C♭). It should be noted that using the traditional prior art notation system, the sharps or flats of any key signature would be placed at different locations on the lines and spaces of the treble clef staff and the bass clef staff. Using the staff 120 of the present invention, the key signatures have the same placement of the sharps or flats on the treble clef staff subportion 128 and on the bass clef staff subportion 130. Therefore, each key signature 146 has the same appearance on the treble clef portion 122 as on the bass clef portion 124.

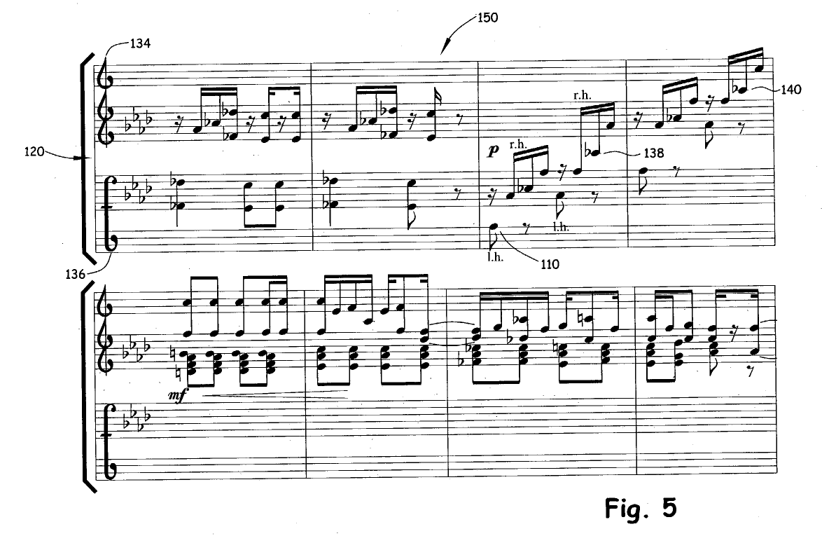

FIG. 5 illustrates music scored using a staff 150 of the present invention. The music scored on the staff 150 in FIG. 5 corresponds to the first six bars of the musical composition illustrated in FIG. 1 using the prior art notation system. Some of the advantages of staff of the present invention can be noted when comparing FIG. 1 to FIG. 5. One advantage of staff of the present invention is that the only note to appear on a ledger line is C. In FIG. 1 it is apparent that many ledger lines must be used to indicate high tones as well as one of the low notes. The staff of the present invention eliminates the need to count ledger lines and enables musicians to read notes that are multiple octaves above or below middle C with ease.

The 4-6-6-4 pattern of staff of the present invention also has several advantages. The 4-6-6-4 pattern is favored over a 5-5-5-5 pattern, which also has 20 lines and spaces, because the 4-6-6-4 pattern is visually distinct from a 5-5-5-5 pattern. When a 5-5-5-5 pattern is used, each subportion of the staff looks like the other subportions. Using a 4-6-6-4 pattern, it is simpler to locate middle C. This is because the midpoint of the staff of the present invention grid is much more apparent using a 4-6-6-4 pattern. The midpoint of staff of the present invention is located between the treble 6-lines subportion 128 and the bass 6-line subportion 130. This orientation is readily apparent when scanning the music, and allows for rapid orientation by the musician when reading the music for the first time.

Another advantage of the 4-6-6-4 pattern is that the subportions of 6 lines along with the single ledger line provides for seven lines, so that exactly two whole octaves fit on the staff subportion. In other words, with a note C on the lower ledger line and a 6-line staff subportion, another note C, two octaves higher, will appear on the upper ledger line. Using the prior art notation system, for example, the octaves did not exactly fit on a staff, so that the upper and lower ledger lines contained different notes. Since each 6-line staff subportion fits exactly two octaves, the same note always appears at the same location in each 6-line staff subportion. In other words, the note E always appears on the first line from the bottom in both the treble clef 6-line staff subportion and the bass clef 6-line staff subportion, the note G always appears on the next line up, the note B always appears on the line above that, the note D always appears on the line above that, the note F always appears on the line above that, and the note A always appears on the top line of each 6-line staff subportion. This relationship can be seen by comparing the note placements shown in FIG. 3.

The treble clef symbol 134 and the bass clef symbol 136 are also advantageous over prior art clef symbols. The treble clef symbol 134 not only indicates G above middle C, but it also indicates the Gs in the next two octaves. The bass clef symbol 136 is similarly advantageous in that it indicates not only the F below middle C, but also the Fs in the next two lower octaves. Prior art clef symbols only indicated the G and F above and below middle C, respectively. These advantages translate into faster readability for music noted using staff of the present invention, since each G and F line or space is marked.

It should be realized that the embodiment described herein is only representative of the invention and is not intended to limit the invention to one particular embodiment as the invention includes all embodiments falling within the scope of the appended claims. Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. A musical notation system comprising a musical staff for receiving notes indicating the pitch and duration of the music, the staff comprising a grid of 20 horizontal lines with horizontal spaces between each of the lines for placement of the notes on the lines or in the spaces to indicate the pitch of the note, 10 of the lines forming a treble clef staff portion and 10 of the lines forming a bass clef staff portion, the treble staff portion being located above the bass staff portion, each 10-line staff portion being divided into two staff subportions with one staff subportion having 4 lines and another staff subportion having 6 lines

2. The musical notation system of claim 1, wherein all of the lines in each of the staff subportions are equally spaced from each other, and wherein each staff subportion is spaced from an adjacent staff subportion by a discernibly greater distance that the space between the lines in each staff subportion

3. The musical notation system of claim 2, wherein the space between each adjacent staff subportion is sufficient for the placement of a single ledger line.

4. The musical notation system of claim 3, wherein the single ledger line is always used to designate a note C.

5. The musical notation system of claim 1, wherein the 4-line staff subportion of the treble clef staff portion is located above the 6-line staff subportion of the treble clef staff portion.

6. The musical notation system of claim 1, wherein the 4-line staff subportion of the bass clef staff portion is located below the 6-line staff subportion of the bass clef staff portion.

7. The musical notation system of claim 1, wherein the treble clef staff portion further comprises a treble clef, and wherein the treble clef identifies each line and space where the note G may be placed in each octave.

8. The musical notation system of claim 1, wherein the bass clef staff portion further comprises a bass clef, and wherein the bass clef identifies each line and space where the note F may be placed in each octave.

9. The musical notation system of claim 1, wherein the arrangement of notes on the 6-line subportion of the treble clef staff portion is identical to the arrangement of notes on the 6-line subportion of the bass clef staff portion.

10. The musical notation system of claim 1, wherein a key signature comprising sharps or flats is arranged on the treble clef staff and/or the bass clef staff, and wherein the arrangement of sharps or flats on the treble clef staff is identical to the arrangement of sharps or flats on the bass clef staff for any key signature.
